(19) United States
(12) Patent Application Publication
(10) Pub. No.: US 2021/0045520 A1
(43) Pub. Date: Feb. 18, 2021

(54) GRILL CLEANING TOOL, METHOD, AND USE THEREOF

(71) Applicant: John B. Canney, Burlington (CA)

(72) Inventor: John B. Canney, Burlington (CA)

(21) Appl. No.: 16/991,079

(22) Filed: Aug. 12, 2020

Related U.S. Application Data
(60) Provisional application No. 62/922,522, filed on Aug. 14, 2019.

(51) Int. Cl. A46B 11/00; A46B 5/00; A47L 25/00; B08B 1/00; A47J 37/07; A47J 37/10

(52) U.S. Cl. CPC A46B 11/0062; A46B 5/0095; A47L 25/00; A46B 2200/3093; A47J 37/0786; A47J 37/106; B08B 1/002

(57) ABSTRACT

A cleaning tool, use thereof, and a method for cleaning a hot grill is provided. The cleaning tool comprises a hollow handle for holding a liquid, the handle having a first coupling mechanism fixed to said handle. The cleaning tool also includes a brush head having a second coupling mechanism fixed to the brush head, the second coupling mechanism releasably securable to the first coupling mechanism, a heat resistant scrubbing pad extending therefrom, and an outlet in fluid communication with the hollow handle. The outlet is positioned proximate the scrubbing pad to expel the liquid therefrom. The scrubbing pad is adapted to withstand temperatures of at least 100 degrees Celsius, such that when liquid flows through the outlet onto the heated grill, the heat of the grill vaporizes the liquid into steam, which helps to clean the grill in combination with the scrubbing pad.

### TECHNICAL FIELD

The present invention relates to cleaning tools and cleaning devices.

### BACKGROUND OF THE INVENTION

Brushes are common tools used to clean barbeques grills. Conventional grill cleaning brushes typically comprise bristles attached to a brush head that is secured or otherwise mounted on a handle. They are typically applied to scrub a cold or cooled grill after the grill has been soaking in dish soap for a period of time.

Such a process is often time-consuming and requires a great deal of scrubbing on the part of the user for a thorough clean.

### BRIEF SUMMARY OF THE INVENTION

There is provided a cleaning tool comprising: a hollow handle for holding a liquid, the handle having a first coupling mechanism fixed to or integral with said handle; and a brush head having: a second coupling mechanism fixed to or integral with the brush head, the second coupling mechanism releasably securable to the first coupling mechanism, a heat resistant scrubbing pad extending therefrom, and an outlet in fluid communication with the hollow handle, the outlet positioned proximate the heat resistant scrubbing pad to expel the liquid therefrom; wherein the heat resistant scrubbing pad is adapted to withstand temperatures of at least 100 degrees Celsius.

There is also provided a method of cleaning a grill with a cleaning tool, the cleaning tool comprising: a hollow handle for holding a liquid, the handle having a first coupling mechanism fixed to or integral with said handle; and a brush head in fluid communication with the hollow handle and having a second coupling mechanism fixed to or integral with the brush head, the second coupling mechanism releasably securable to the first coupling mechanism, a heat resistant scrubbing pad extending therefrom, and an outlet in fluid communication with the hollow handle, the outlet positioned proximate the heat resistant scrubbing pad to expel the liquid therefrom; the method comprising: heating the grill to at least 100 degrees Celsius; filling the hollow handle with a liquid; scrubbing the grill with the heat resistant scrubbing pad, wherein when the liquid flows through the outlet onto the grill, the heat of the grill vaporizes the liquid to create steam, which cleans the grill in combination with the heat resistant scrubbing pad.

There is further provided use of a cleaning tool to clean a grill that is heated to at least 100 degrees Celsius, the cleaning tool comprising: a hollow handle for holding a liquid, the handle having a first coupling mechanism fixed to or integral with said handle; and a brush head in fluid communication with the hollow handle and having: a second coupling mechanism fixed to or integral with the brush head, the second coupling mechanism releasably securable to the first coupling mechanism, a heat resistant scrubbing pad extending therefrom, and an outlet in fluid communication with the hollow handle, the outlet positioned proximate the heat resistant scrubbing pad to expel the liquid therefrom; wherein when the liquid flows through the outlet onto the grill, the heat of the grill vaporizes the liquid to create steam, which cleans the grill in combination with the heat resistant scrubbing pad.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a front perspective view of a cleaning tool according to an example embodiment of the present invention;

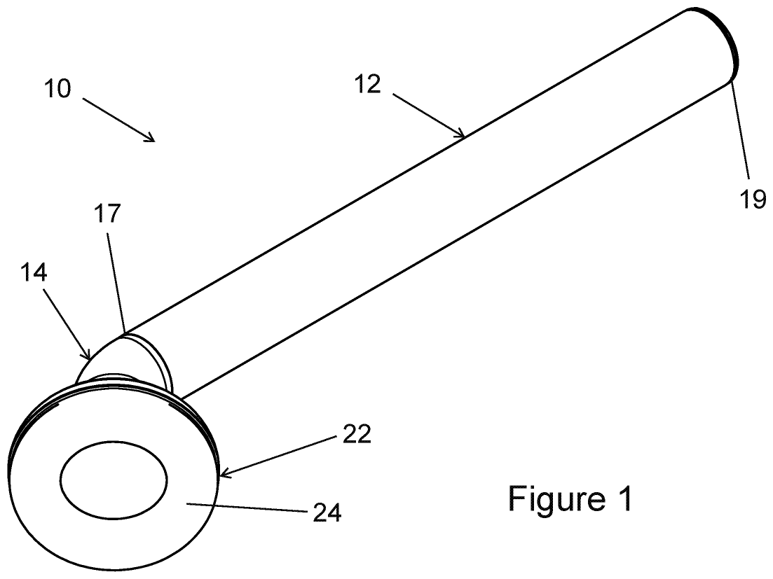

FIG. 2 is a rear perspective view of the cleaning tool of FIG. 1;

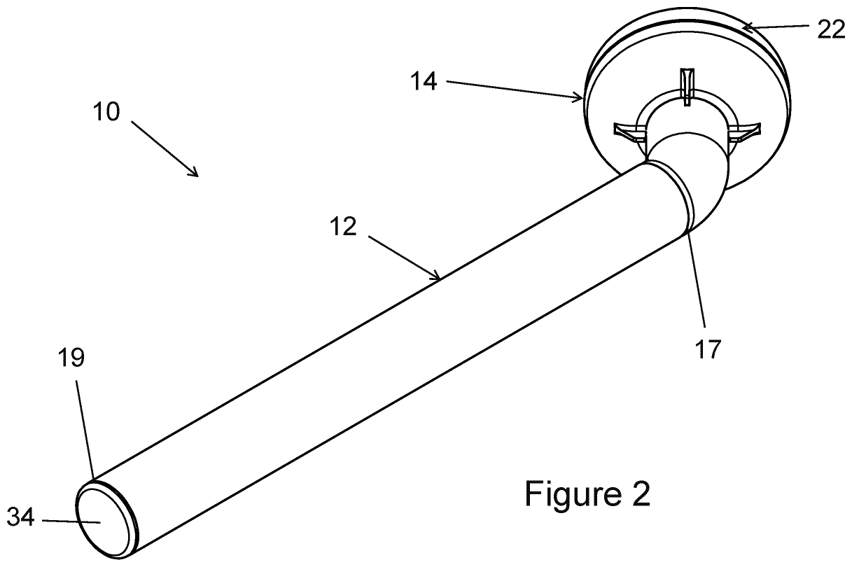

FIG. 3 is a side elevational view of the cleaning tool of FIG. 1;

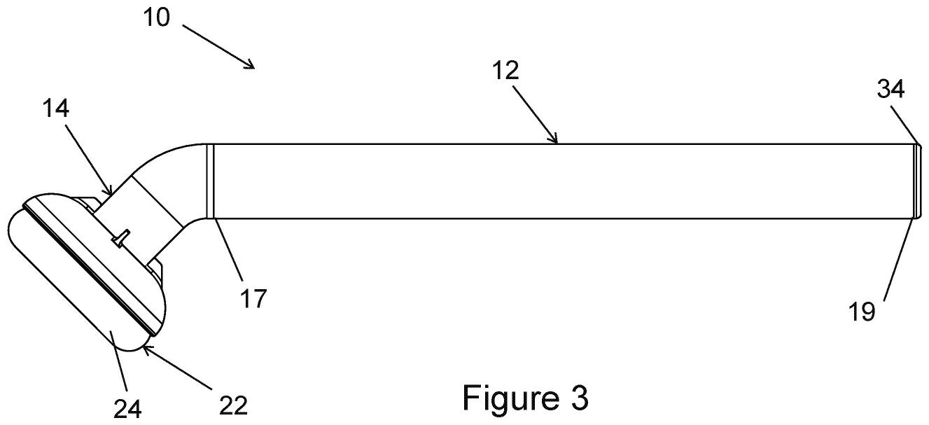

FIG. 4 is a cross-sectional view along line 4-4 of FIG. 3; and

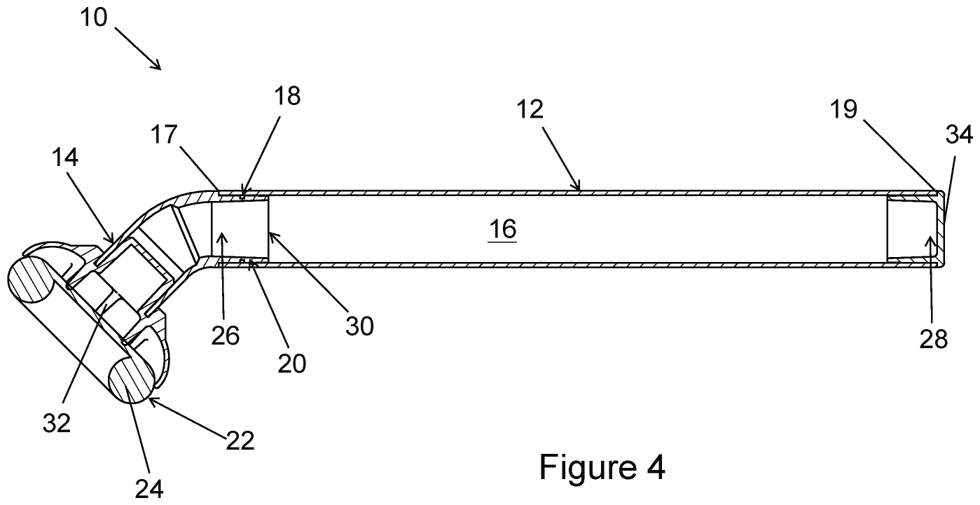

FIG. 5 is a flow chart illustrating a method of cleaning a grill according to an example embodiment of the present invention.

### DETAILED DESCRIPTION OF PREFERRED EMBODIMENTS

The present invention may be embodied in a number of different forms. The specification and drawings that follow describe and disclose some of the specific forms of the invention.

In the attached drawings, a grill cleaning tool constructed in accordance with the present invention is represented generally by reference character 10. As shown in the Figures, cleaning tool 10 generally comprises a hollow handle 12 and a brush head 14.

Hollow handle 12 notably includes a hollow or interior space 16 for holding a liquid (not shown) therein. In the depicted embodiment, hollow handle 12 includes a first end 17 and a second end 19, with a first coupling mechanism 18 fixed to or integral with hollow handle 12 proximate first end 17. First end 17 and second end 19 each also have an opening, respectively first and second openings 26, 28, which allow access to interior space 16.

As shown, hollow handle 12 also includes a cap 34 that is operatively coupled to second end 19 to help enclose interior space 16 and cover second opening 28. Hollow handle 12 may be formed entirely from a solid material. Alternately, at least a portion of hollow handle 12 may be formed from a flexibly resilient material.

Hollow handle 12 may also include a hook or loop extending therefrom, for hanging and storing cleaning tool 10 when it is not in use. The hook or loop may be positioned at second end 19 or along hollow handle 12, between first end 17 and second end 19.

Brush head 14 has a second coupling mechanism 20 fixed to or integral with brush head 14. Second coupling mechanism 20 is releasably securable to first coupling mechanism 18. In the depicted embodiment, brush head 14 has a third opening 30 at one end, to which second coupling mechanism 20 is proximately positioned.

First and second coupling mechanisms 18, 20 may be a variety of mechanisms that are releasably securable to one another. For example, first and second coupling mechanisms 18, 20 may be correspondingly threaded portions, such that first coupling mechanisms 18 may be releasably threaded in second coupling mechanisms 20. Alternately, at shown, first and second coupling mechanisms 18, 20 may comprise snap-fit components to allow brush head 14 to snap into hollow handle 12.

In this manner, other attachments with the corresponding second coupling mechanisms 20, other than brush head 14, may be interchangeably secured to first coupling mechanisms 18. For example, a basting brush with second coupling mechanisms 20 may be releasably secured to hollow handle 12 via first coupling mechanisms 18. In such an application, the basting brush would also be in fluid communication with interior space 16 of hollow handle 12.

Brush head 14 further includes a heat resistant scrubbing pad 22 secured thereto and extending therefrom. Heat resistant scrubbing pad 22 is adapted to withstand temperatures of at least 100 degrees Celsius. In that regard, heat resistant scrubbing pad 22 may be formed from a number of materials that have a melting point significantly higher than 100 degrees Celsius. For example, in the depicted embodiment, heat resistant scrubbing pad 22 is made of coiled copper 24.

Brush head 14 is further shown to have an aperture or outlet 32 positioned proximate heat resistant scrubbing pad 22. Outlet 32 is configured to be in fluid communication with third opening 30 and, by extension, in fluid communication with interior space 16 of hollow handle 12.

In the present embodiment, when second coupling mechanism 20 is releasably secured to first coupling mechanism 18, third opening 30 of brush head 14 is inserted into first opening 26 of hollow handle 12. The nesting of brush head 14 into hollow handle 12 brings outlet 32, and optionally scrubbing pad 22, of brush head 14 into fluid communication with interior space 16 of hollow handle 12.

In this manner, when hollow handle 12 is lifted above brush head 14, gravity may cause the first liquid within interior space 16 to flow from hollow handle 12, past first and third openings 26, 30, through outlet 32 into or around heat resistant scrubbing pad 22, and onto the grill to be cleaned (not shown). If hollow handle 12 has a flexibly resilient portion, the flexibly resilient portion may be squeezed to cause the first liquid within interior space 16 to flow from hollow handle 12 onto the grill.

Since heat resistant scrubbing pad 22 is adapted to withstand temperatures of at least 100 degrees Celsius, the liquid may also be adapted to sustain cleaning properties when heated, such as to at least 100 degrees Celsius. For example, cleaning tool 10 may include water within interior space 16, beer, or one of a number of other liquids for cleaning a grill. When the liquid flows through outlet 32 onto a heated grill, the heat of the grill vaporizes the liquid into steam. The steam, in combination with scrubbing from heat resistant scrubbing pad 22, helps to clean the heated grill.

Cleaning tool 10 may alternately, and/or subsequently, be used with a second liquid, such as oil. Oil flowing through outlet 32 and/or heat resistant scrubbing pad 22 may be applied to the grill prior to cooking and/or after cleaning. If a basting brush is releasably secured to hollow handle 12 instead of brush head 14, the liquid in hollow handle 12 may be a sauce.

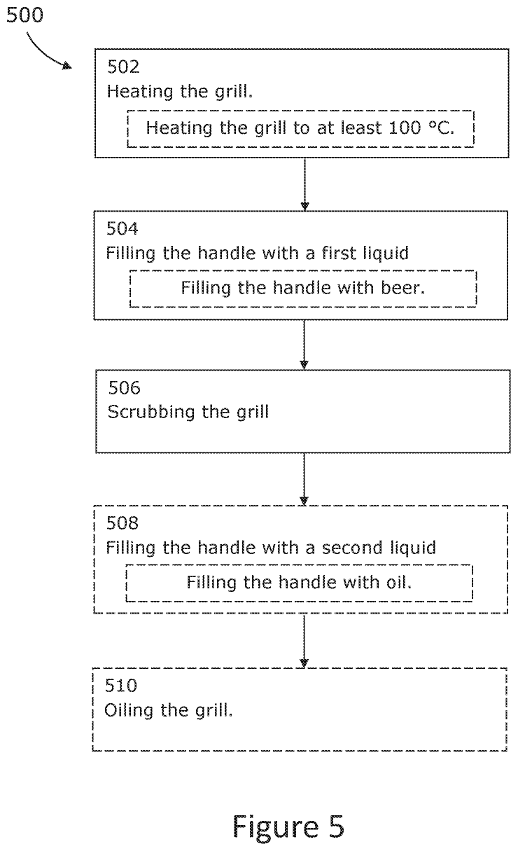

A method 500 of cleaning a grill with cleaning tool 10 in accordance with another embodiment of the present invention is also provided, see FIG. 5. Method 500 includes heating the grill at 502, such as to at least 100 degrees Celsius, filling hollow handle 12 with a first liquid at 504, and scrubbing the grill with heat resistant scrubbing pad 22 at 506. As understood by the skilled person, hollow handle 12 may, alternately, be filled with the first liquid before or during the heating of the grill.

As noted above, in use, scrubbing the grill with heat resistant scrubbing pad 22 requires lifting of hollow handle 12 above brush head 14, thus allowing gravity to pull the liquid within interior space 16 to flow past first and third openings 26, 30, through outlet 32, into or around heat resistant scrubbing pad 22, and onto the heated grill to be cleaned.

If the first cleaning liquid has a lower or higher boiling point than water, the grill may be heated to the corresponding boiling point, which may be lower or higher than 100 degrees Celsius.

In one application, the filling of hollow handle 12 with the first liquid may comprise removing cap 34 from second end 19 of hollow handle 12, injecting the liquid into interior space 16 through second end 19, and replacing cap 34 back onto second end 19.

In another application, the filling of hollow handle 12 with the first liquid may comprise removing brush head 14 from hollow handle 12 by releasably detaching first coupling mechanism 18 from second coupling mechanism 20. After the first liquid is injected into interior space 16 through first end 17, brush head 14 may be releasably reattached to hollow handle 12.

When the first liquid flows through outlet 32/heat resistant scrubbing pad 22 onto the heated grill, the heat of the grill vaporizes the first liquid to create steam. The steam, in combination with scrubbing from heat resistant scrubbing pad 22, helps to clean the heated grill.

In the above method, hollow handle 12 may be filled with water, beer, cleaning solution, or another cleaning liquid. Preferably, the liquid would maintain cleaning properties when heated, such as to 100 degrees Celsius or its corresponding boiling point.

Hollow handle 12 may subsequently be filled with a second liquid at 508, such as oil, for oiling the grill at 510.

A use of cleaning tool 10 to clean a grill that is heated, such as to at least 100 degrees Celsius, in accordance with a further embodiment of the present invention is also provided. As described above, the present use of cleaning tool 10 includes use of heat resistant scrubbing pad 22 on a heated grill, wherein when the liquid flows through outlet 32 onto the grill, the heat of the grill vaporizes the liquid to create steam, which cleans the grill in combination with heat resistant scrubbing pad 22.

As also described above, cleaning tool 10 may be used with beer or another liquid which has cleaning properties when heated. If the cleaning liquid has a lower or higher boiling point than water, the grill may be heated to the corresponding boiling point temperature, which may be lower or higher than 100 degrees Celsius.

Hollow handle 12 may subsequently or alternately be used with a second liquid, such as oil, for oiling the grill.

The above described method and use may be applied to a number of heated grills, including barbeque grills and commercial flat grills.

It is to be understood that what has been described are example embodiments of the invention. The scope of the claims should not be limited by the embodiments set forth above, but should be given the broadest interpretation consistent with the description as a whole.

What is claimed is:

1. A cleaning tool for cleaning a heated grill, the cleaning tool comprising:
a hollow handle for holding a liquid, the handle having a first coupling mechanism fixed to or integral with said handle; and
a brush head having
a second coupling mechanism fixed to or integral with the brush head, the second coupling mechanism releasably securable to the first coupling mechanism,
a heat resistant scrubbing pad extending therefrom, and
an outlet in fluid communication with the hollow handle, the outlet positioned proximate the heat resistant scrubbing pad to expel the liquid therefrom;
wherein the heat resistant scrubbing pad is adapted to withstand temperatures of at least 100 degrees Celsius, such that when the liquid flows through the outlet onto the heated grill, the heat of the grill vaporizes the liquid into steam, which helps to clean the grill in combination with the heat resistant scrubbing pad.

2. The cleaning tool of claim 1, wherein the heat resistant scrubbing pad is made of copper.

3. The cleaning tool of claim 1, further comprising beer in the hollow handle.

4. A method of cleaning a grill with a cleaning tool, the cleaning tool comprising:
a hollow handle for holding a liquid, the handle having a first coupling mechanism fixed to or integral with said handle; and
a brush head in fluid communication with the hollow handle and having
a second coupling mechanism fixed to or integral with the brush head, the second coupling mechanism releasably securable to the first coupling mechanism,
a heat resistant scrubbing pad extending therefrom, the heat resistant scrubbing pad adapted to withstand temperatures of at least 100 degrees Celsius, and
an outlet in fluid communication with the hollow handle, the outlet positioned proximate the heat resistant scrubbing pad to expel the liquid therefrom;
the method comprising:
heating the grill;
filling the hollow handle with a first liquid; and
scrubbing the grill with the heat resistant scrubbing pad, wherein when the liquid flows through the outlet onto the grill, the heat of the grill vaporizes the liquid into steam, which helps to clean the grill in combination with the heat resistant scrubbing pad.

5. The method of claim 4, wherein the grill is heated to at least 100 degrees Celsius.

6. The method of claim 4, further comprising:
removing the brush head from the hollow handle prior to filling the hollow handle with the first liquid; and
reattaching the brush head to the hollow handle after filling the hollow handle with the first liquid.

7. The method of claim 4, wherein the first liquid is water.

8. The method of claim 4, wherein the first liquid is beer.

9. The method of claim 4, further comprising filling the hollow handle with a second liquid after scrubbing the grill with the heat resistant scrubbing pad.

10. The method of claim 4, wherein the grill is a flat grill.

11. Use of a cleaning tool to clean a grill that is heated to at least 100 degrees Celsius, the cleaning tool comprising:
a hollow handle for holding a liquid, the handle having a first coupling mechanism fixed to or integral with said handle; and
a brush head in fluid communication with the hollow handle and having
a second coupling mechanism fixed to or integral with the brush head, the second coupling mechanism releasably securable to the first coupling mechanism,
a heat resistant scrubbing pad extending therefrom, and
an outlet in fluid communication with the hollow handle, the outlet positioned proximate the heat resistant scrubbing pad to expel the liquid therefrom;
wherein when the liquid flows through the outlet onto the grill, the heat of the grill vaporizes the liquid into steam, which helps to clean the grill in combination with the heat resistant scrubbing pad.

12. The use of claim 11, wherein the liquid in the hollow handle is beer.

13. The use of claim 11, further comprising subsequently using the cleaning tool to oil the grill, wherein the liquid in the hollow handle is oil.

14. The use of claim 11, wherein the grill is a flat grill.
